(19) United States
(12) Patent Application Publication
(10) Pub. No.: US 2005/0241381 A1
(43) Pub. Date: Nov. 3, 2005

(54) Tire pressure gauge with guiding sleeve

(76) Inventor: James Thomas Bosler, San Francisco, CA (US)

Correspondence Address: JAMES T. BOSLER, 7 EUGENIA AV, SAN FRANCISCO, CA, 94110-5411, US

(21) Appl. No.: 11/120,022

(22) Filed: May 2, 2005

Related U.S. Application Data
(60) Provisional application No. 60/567,581, filed on May 3, 2004.

(51) Int. Cl. G01M 17/02

(52) U.S. Cl. 73/146

(57) ABSTRACT

A hand-held tire pressure measuring instrument comprising a pneumatic tire pressure gauge and a guiding sleeve which surrounds its air receptor while allowing its limited bi-directional movement within. Upon being seated on a tire valve stem, the guiding sleeve aligns the gauge to the stem at the optimal angle and coaxial approach for an accurate measurement to occur with minimal air loss.

### CROSS-REFERENCE TO RELATED APPLICATIONS

PPA 60/567581 May 03, 2004

### FEDERALLY SPONSORED RESEARCH

Not applicable

### SEQUENCE LISTING OR PROGRAM

Not applicable

### BACKGROUND OF THE INVENTION

1. Field of Invention

This invention relates to a pneumatic tire pressure gauge with a permanently affixed guiding sleeve around its air receptor, so as to provide alignment with a tire valve stem at the optimal angle and coaxial approach for obtaining an accurate air pressure reading with minimal air loss.

2. Prior Art

The most popular type of tire gauge is the pen type, so called because it resembles one and usually even has a pocket clip like a pen does. It is used by firmly pressing its air receptor end against a valve stem opening, which depresses the air release needle inside the stem. That allows air to flow from inside the tire into the gauge, where the air pressure forces a calibrated bar out the other end of the gauge to an extent that represents the air pressure.

There are several other types that are used the same way, such as dial and LCD gauges. Then there are those that are screwed onto the stem and left there, providing a continuous reading until unscrewed. They are not very popular though because they can easily be stolen. There are myriad other types that are rarer still, such as those that sample the tire's surface tension, or incorporate electrical signals, sound waves or magnets.

The pen type though is the most popular. Most folks know how to use it, and it is regarded as trustworthy. The problem however is that its air receptor end has to be slightly angled in order for its main body to be far enough away from the wheel's hub cap for a user to be able to hold onto it, which is necessary because it doesn't affix to the stem but rather has to be held upon it. Such is the angle of that stumpy little end that it is difficult to visually determine whether it is at the proper angle to the stem in order to obtain a good reading without letting at least some air escape from the tire.

This is even more likely to occur when the user can't see very well, such as in a dark garage or at night, as is often the case. Adding to the difficulty is that tire stems are made of rubber, moving unpredictably when one applies necessary force to the gauge. This can create great angular torque, which can leverage back and cause the gauge to slip out of the user's hand. As people are usually squatting at the time, this phenomenon can even cause them to lose their balance and even fall forward into the car's side panel.

As to its history, the pen-type gauge began showing up around World War I, when the first automotive armies required a compact means of determining tire pressure. It hasn't changed very much since, even though now there is a greater need for pressure accuracy: cars go much faster and much farther, so tire pressure is more important in minimizing gasoline consumption.

Even so, many if not most people still drive around with low air pressure. Ask one, and the likely responses are that it is time consuming and physically difficult to use a tire gauge, that it is hard to obtain a good reading, and that the effort is often counter productive because air is lost in the process. It often hastens the trip to the gas station for more air, which takes more time and uses more fuel. In lesser-developed nations it often means traveling several miles, sometimes through dangerous terrain. And then there are the millions of smaller tires, on motorcycles, scooters, bicycles and such, for which even a small air loss means having to go get the pump.

Objects and Advantages

The present invention incorporates a “guiding sleeve” which permanently surrounds the air receptor end of a conventional pen-type tire gauge: that end which comes in contact with the tire valve stem. The guiding sleeve is affixed to or fitted onto the stem to hold the gauge steady for the test and also to ensure that it will be brought into contact with the stem at the proper angle and coaxial approach in order to obtain an accurate air pressure reading with minimal air escape.

Specifically, the guiding sleeve fits securely over the metal threaded portion of the stem, the size of which is common among almost all types of vehicles—cars, trucks, bicycles, golf carts etc—except for some bicycles from Europe that have thinner “presto” valves, for which a specially-designed version would be appropriate.

One advantage of the present invention is that once fitted onto the stem, the gauge remains there until the user takes it off. This means that one gets to have both hands free to steady one self and get ready to take a good test. It takes both hands with a regular pen gauge: one to hold it at the proper coaxial alignment with the stem, and the other to press down on it for the reading. That makes things crowded, and can make one's wrists or cuffs impede the calibrated bar as it shoots out, invalidating the pressure test. But with the guiding sleeve fitted on the stem, both hands don't need to be in there; just one is needed. One thumb, actually, to apply the necessary pressure to make the reading occur.

These advantages mean that the testing will be done in less time, will be less difficult physically, will result more in good readings, and will lose less air in the process.

### SUMMARY

In accordance with the present invention, a tire pressure gauge includes a guiding sleeve, which permanently surrounds the gauge's air receptor yet allows its free bidirectional movement within. When the guiding sleeve is seated upon a tire stem, the air receptor within can be pushed into contact with the valve stem at the proper angle and coaxial alignment to obtain an accurate measurement with minimal air loss.

### DRAWINGS—FIGURES

FIG. 1 is a perspective view illustrating the preferred embodiment guiding sleeve, as attached to a typical pen-type tire gauge.

FIG. 2 is a view of the second embodiment guiding sleeve, as attached to a typical pen-type tire gauge.

FIG. 3 is a view of the third embodiment guiding sleeve, as it would appear as assembled without a tire gauge and the button installed within it.

FIG. 4 is a view of the third embodiment guiding sleeve, as attached to a typical pen-type tire gauge.

FIG. 5 is a front view of the first embodiment guiding sleeve, as it would appear as assembled without a tire gauge installed within it.

FIG. 6 is a top view of the first embodiment guiding sleeve, as it would appear as assembled without a tire gauge installed within it.

FIG. 7 is a side view of the push-button piece.

FIG. 8 shows the interior of the left wall piece of the housing assembly.

FIG. 9 shows a cutaway view of the complete assembly with a pen-type tire gauge installed within it, as placed over a conventional tire stem.

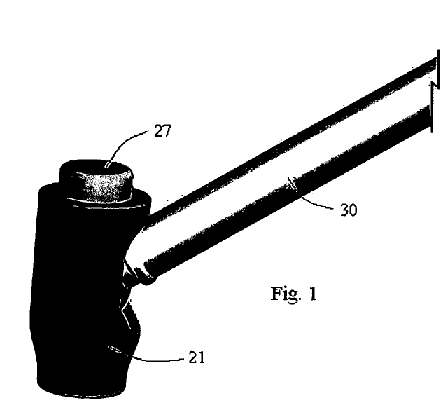

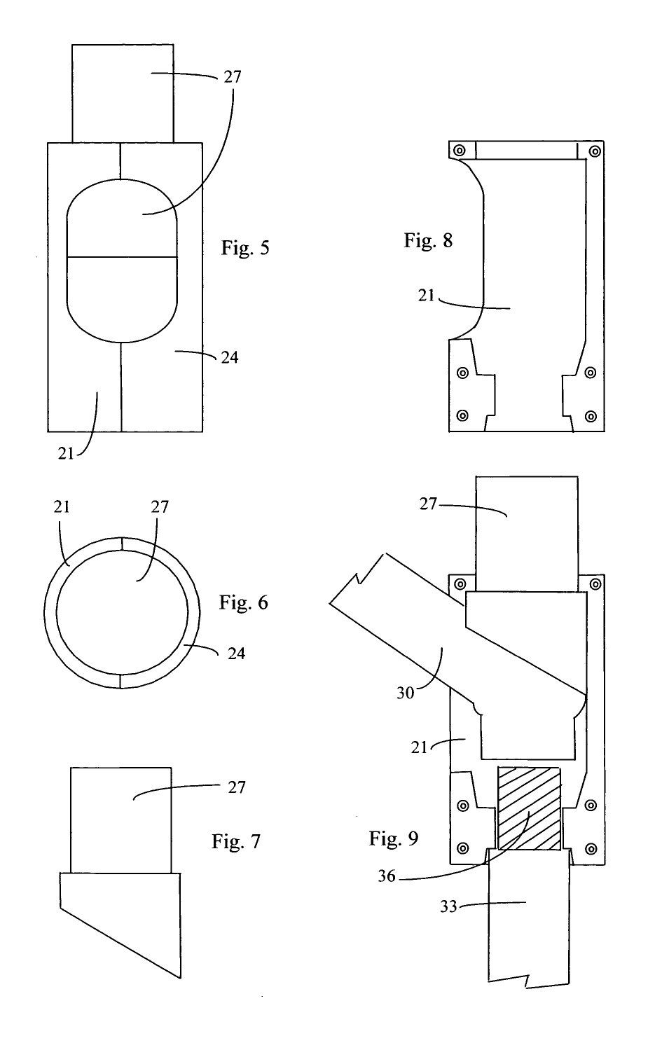

### PREFERRED EMBODIMENT—FIGS. 1 AND 5 THROUGH 9—DESCRIPTION

A preferred embodiment is shown in FIG. 1 as affixed to the end of a conventional pen-type tire gauge 30. The left wall piece 21 and the right wall piece surround the end of such a gauge so that it is permanently retained within, yet is allowed slight vertical movement. A push-button piece 27 is permanently attached to the tire gauge and is allowed vertical movement in unison with that gauge.

FIG. 9 is an internal view of the fully assembled preferred embodiment as it would appear as placed upon a standard tire stem 33 and 36.

### PREFERRED EMBODIMENT—FIGS. 1 AND 5 THROUGH 9—OPERATION

With thumb and forefinger, the user grasps the guiding sleeve wall 21 and places the bottom hole of the guiding sleeve over the metal threads 36 of a tire valve stem. The user then pushes with thumb or finger upon the button 27, which pushes the tire gauge 30 downward so that it depresses the central displacement needle inside the valve stem. That releases air from the tire into the tire gauge, resulting in a pressure reading on the gauge. The user immediately releases the push-button, at which point either the spring inherent in such a valve stem or the air pressure within the tire returns the needle to its pre-test position preventing the release of additional air. The housing assembly can then be removed from the stem to facilitate the reading of the pressure.

### PREFERRED EMBODIMENT—FIGS. 1 AND 5 THROUGH 9—ADVANTAGES

Besides those advantages mentioned in the Objects and Advantages section above, the preferred embodiment is easily attached, operated and removed with one hand. It slides comfortably yet securely over the metal threaded part of a valve stem, and so it is not necessary to screw it on or otherwise attach it.

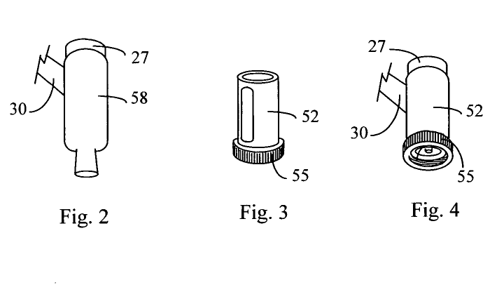

### SECOND EMBODIMENT—FIG. 2—DESCRIPTION

The second embodiment is the same as the preferred embodiment, but with a skirted stem receptor feature on its housing assembly 58.

### SECOND EMBODIMENT—FIG. 2—OPERATION

The operation of the second embodiment is the same as that of the preferred embodiment.

### SECOND EMBODIMENT—FIG. 2—ADVANTAGES

The skirted stem receptor makes it easier in certain application to place it on the stem, and lends additional stability by securing internally against the rubber part of the stem as well as its threaded part.

The preferred embodiment is more is more compact though, and so can fit in tighter places such as between wheel spokes, hubcap rims, axels and lug nuts.

### THIRD EMBODIMENT—FIGS. 3 & 4—DESCRIPTION

The third embodiment is the same as the preferred embodiment, but with an internally threaded tire stem receptor 55 attached to the housing assembly 52 but which turns independently of it.

### THIRD EMBODIMENT—FIGS. 3 & 4—OPERATION

The operation of the third embodiment is the same as that of the preferred embodiment, except that it is secured to the valve stem by screwing the stem receptor onto it. Then after the air pressure test is taken, it is unscrewed and removed.

### THIRD EMBODIMENT—FIGS. 3 & 4—ADVANTAGES

Screwing it on to the valve stem provides more stability during testing than the preferred embodiment provides, and further reduces potential air loss during the test.

The preferred embodiment is applied much more quickly though, for it is simply placed over the stem rather than screwed on, and then simply lifted off rather than screwed off. The preferred embodiment is also less costly to manufacture because it is comprised of fewer parts.

### FURTHER EMBODIMENTS

Although the descriptions of these embodiments contain many specifics, they should not be construed as limiting the scope of the invention but as merely providing illustrations of some of the presently preferred embodiments of this invention. For example, each wall piece 21 of the housing assembly could be tapered at the bottom so as to fit inside the valve stem hole of a wheel rim, in order to better access the tire stem it contains.

And though the addition of a guiding sleeve to a pen-type gauge has been illustrated and described, it is not intended to limit this invention to be applied only to that type of gauge. Indeed, it could be applied to any type that would be improved with such a guiding sleeve.

1. A hand-held tire pressure measuring instrument comprising:
(a) a device which measures the air pressure of a tire by pressing its air receptor onto the tire's valve stem
(b) a guiding sleeve, surrounding though allowing limited vertical movement to said air receptor, and having a hole in its bottom end to securely accommodate such stem

2. The instrument of claim 1 wherein a push-button protrudes from a hole in the top end of said guiding sleeve, and is affixed to said device at that point within said guiding sleeve that is topmost.

3. The instrument of claim 2 wherein the device is a pen-type tire gauge.

4. A hand-held tire pressure measuring instrument comprising:
(a) a device which measures the air pressure of a tire by pressing its air receptor onto the tire's valve stem
(b) a guiding sleeve, surrounding though allowing limited vertical movement to said air receptor, and having a hole in its bottom end to securely accommodate such stem
(c) a tire valve stem receptor, affixed to the bottom end of said guiding sleeve though capable of independent rotation, and which is internally threaded so as to accommodate the screw threads of such stem

5. The instrument of claim 4 wherein a push-button protrudes from a hole in the top end of said guiding sleeve, and is affixed to said device at that point within said guiding sleeve that is topmost.

6. The instrument of claim 5 wherein the device is a pen-type tire gauge.
